(19) United States
(12) Patent Application Publication
(10) Pub. No.: US 2010/0273452 A1
(43) Pub. Date: Oct. 28, 2010

(54) Apparatus and Methods For Locating Tracking and/or Recovering a Wireless Communication Device

(75) Inventors: Rajeev Durai Rajann, San Diego, CA (US); Thomas Francis Doyle, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/726,562

(22) Filed: Mar. 18, 2010

Related U.S. Application Data
(60) Provisional application No. 61/172,765, filed on Apr. 26, 2009.

(51) Int. Cl. H04W 24/00; H04W 12/00

(52) U.S. Cl. 455/411; 455/456.2

(57) ABSTRACT

A method and apparatus for facilitating location of a targeted wireless communications device (WCD) is provided. The method may comprise, enabling a location module in response to receiving a location state code, wherein the location module includes one or more location state routines, wherein at least one of the one or more location state routines is identified in the location state code, and wherein each location state routine includes at least one location functionality, and executing the at least one location functionality associated with the one or more location state routines identified by the received location state code.

### CLAIM OF PRIORITY UNDER 35 U.S.C. §119

The present Application for Patent claims priority to Provisional Application No. 61/172,765 filed Apr. 26, 2009, and assigned to the assignee hereof and hereby expressly incorporated by reference herein.

### BACKGROUND

1. Field

The disclosed aspects relate to wireless communication devices, and more particularly, to systems, methods and apparatus for locating and/or tracking and/or recovering a wireless communication device, especially devices that have been lost, stolen or misplaced.

2. Background

Wireless communication devices have become a prevalent means by which majorities of people worldwide have come to communicate. Wireless communication devices have become smaller and more powerful in order to meet consumer needs and to improve portability and convenience. The smallness and portability of such devices make them highly susceptible to being misplaced, lost or stolen. As the user penetration within the general population increases to include younger aged and senior aged users, the likelihood for misplacing, losing or having a device stolen tends to increase.

While many wireless communication devices are configured to provide password security protection, the password is typically required at device power-up. Thus, if a device has been lost or stolen while the power is on, the finder or the thief can use it as long as the device remains on. In many other instances, users prefer to forego password security protection because logging on each time the device is powered up is viewed as tedious and unnecessary action.

When the user of the wireless communication device is confronted with a situation in which the device is misplaced, lost or stolen, it provides for a troublesome and at times, traumatic experience. The wireless communication device, such as a mobile telephone, is no longer limited to providing a means for placing and receiving communication calls. The increased storage capacity and functionality of the devices may provide the user e-wallet or mobile-office functionality, which allows the user to not only store contact information but also credit card information, valuable and secured personal and business related information and the like. Thus, permanently losing a device and having to replace a lost or stolen device is not merely a matter of just facing the economical burden of purchasing a new device, it may also involve attempting to reacquire lost data, changing previous secure personal and/or business information canceling credit cards and the like.

Users confronted with a misplaced, stolen or lost wireless communication device typically perform one or more standard operations, such as searching for the device, reporting to the authorities that the device has been stolen, contacting the service provider to get services turned off and, if the device is permanently lost or stolen, purchasing a new device. All of these standard options are less than attractive to the user, as they require time, effort, cost and induce stress. In the case of a misplaced device, which is reported as lost for the purpose of disconnecting services and is then subsequently found, the user has to perform the tedious and time-consuming process of re-contacting the service provider to have the service reinstated.

Regardless of whether the wireless communication device is misplaced, lost or stolen it is critical that the device be rendered unusable, either temporarily until the device is found or returned, or permanently if the device is stolen, not found or not returned.

In other situations in which a user loans their device to some one else, such as a parent loaning their device to their child, a need may exist to track the location of the device and/or the corresponding loanee. In another application, it may be advantageous to provide a user a wireless communication device and nefariously track the location of the user or the user's actions. For example, a law enforcement agency may desire to track the whereabouts or actions of a suspected criminal, without the suspected criminal knowing that they are being tracked or their actions being monitored.

Thus a need exists to provide for locating, tracking and/or recovering wireless communication devices that have been misplaced lost, or stolen. As such a need exists to provide disablement and secure the data stored on a wireless communication device that is misplaced, lost or stolen. Additionally, a need also exists, for providing location and action tracking of wireless devices in the instance in which the device has been loaned or to provide covert surveillance by law enforcement of suspected criminals.

### SUMMARY

In accordance with one or more aspects and corresponding disclosure thereof, various aspects are described in connection with facilitating location of a targeted wireless communications device (WCD). According to one aspect, a method for facilitating location of a targeted wireless communications device (WCD) is provided. The method can comprise enabling a location module in response to receiving a location state code, wherein the location module includes one or more location state routines, wherein at least one of the one or more location state routines is identified in the location state code, and wherein each location state routine includes at least one location functionality. Moreover, the method can comprise executing the at least one location functionality associated with the one or more location state routines identified by the received location state code.

Yet another aspect relates to at least one processor configured to facilitate location of a targeted wireless communications device (WCD). The at least one processor can include a first module for enabling a location module in response to receiving a location state code, wherein the location module includes one or more location state routines, wherein at least one of the one or more location state routines is identified in the location state code, and wherein each location state routine includes at least one location functionality. Further, the at least one processor can include a second module for executing the at least one location functionality associated with the one or more location state routines identified by the received location state code.

Still another aspect relates to a computer program product comprising a computer-readable medium. The computer-readable medium can include a first set of codes for causing a computer to enable a location module in response to receiving a location state code, wherein the location module includes one or more location state routines, wherein at least one of the one or more location state routines is identified in the location state code, and wherein each location state routine includes at least one location functionality. Further, the computer-readable medium can include a second set of codes for causing the computer to execute the at least one location functionality associated with the one or more location state routines identified by the received location state code.

Yet another aspect relates to an apparatus. The apparatus can include means for enabling a location module in response to receiving a location state code, wherein the location module includes one or more location state routines, wherein at least one of the one or more location state routines is identified in the location state code, and wherein each location state routine includes at least one location functionality. Moreover, the apparatus can comprise means for executing the at least one location functionality associated with the one or more location state routines identified by the received location state code.

Another aspect relates to an apparatus. The apparatus can include a location recovery module operable to: enable the location recovery module in response to receiving a location state code, wherein the location module includes one or more location state routines, wherein at least one of the one or more location state routines is identified in the location state code, and wherein each location state routine includes at least one location functionality, and execute the at least one location functionality associated with the one or more location state routines identified by the received location state code.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a block diagram of a system for remotely accessing a wireless communication device that has been misplaced, lost or stolen, according to an aspect;

FIG. 2 is a block diagram of the various location and recovery routines executed by a wireless communication device that has been misplaced, lost or stolen, according to an aspect;

FIG. 3 is a block diagram of a system for locating, tracking and/or recovering a targeted wireless communication device, according to another aspect;

FIG. 4 is an example of a communication data packet payload, according to an aspect;

FIG. 5 is a block diagram of a target wireless communication device, according to another aspect;

FIG. 6 is a block diagram of a computing device that attempts to locate, track and/or recover a target wireless communication device, according to an aspect;

FIG. 7 is a block diagram of an exemplary cellular telephone network used in communicating with the targeted wireless communication device, according to an aspect;

FIG. 8 depicts an exemplary flow diagram of a methodology for facilitating location of a targeted wireless communication device according to an aspect; and

FIG. 9 is a block diagram of an exemplary communication system that can facilitate location of a targeted wireless communication device according to an aspect.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The various aspects are described herein are in connection with a wireless communication device. A wireless communication device can also be called a subscriber station, a subscriber unit, mobile station, mobile, remote station, access point, remote terminal, access terminal, user terminal, user agent, a user device, or user equipment. A subscriber station may be a cellular telephone, a cordless telephone, a Session Initiation Protocol (SIP) phone, a wireless local loop (WLL) station, a personal digital assistant (PDA), a handheld device having wireless connection capability, or other processing device connected to a wireless modem.

Present aspects provide for systems, devices, apparatus, methods and computer program products for locating, tracking and attempting to recover, wireless communication devices that have been misplaced, lost or stolen. In this regard, present aspects rely on generating a communication data packet, for example, a Short Message Service (SMS) communication data packet at a secondary wireless device, a web interface or a network service provider device. The communication data packet includes a locating state code that identifies one of a plurality of locating states that are operable on the targeted (i.e., the misplaced, lost or stolen) wireless communication device. The locating states are associated with one or more predetermined routines that are operable on the targeted wireless device. In some aspects, the locating state may be associated with a sequence of routines that are triggered on the device.

The predetermined routines may effectively disable/lock the wireless communication device, disable any application running on the wireless device, such as a communication call application. In addition to disabling or locking the device, the predetermined routines may trigger jamming or scrambling of communication signals, such as voice or data signals. Additionally, the predetermined routines may trigger audible, visual or sensory perceptible alerts to the possessor of the device that identify the device as being lost or stolen. The predetermined routines may additionally capture data, such as geographic location data, image data, audio data and the like and communicate the data to the owner/user of the targeted device, to a network entity device, or to a service provider device. In turn the captured and retrieved information may be used to locate the device and/or the party who is in possession of the targeted device. Also, once data is captured and retrieved from the wireless device, predetermined routines may provide for data to removed/deleted from the device. Additionally, the predetermined routines that capture and communicate data may be operated in a “stealth” mode so that conventional indicators that would normally be presented, such as displayed lights or messages or audible tones, are suppressed to insure that the finder/thief is unaware that these routines are currently being executed. Also, the predetermined routines may change an operational mode, such as changing the targeted device from a “silent” or “vibrate” ring state to an “audible” ring state.

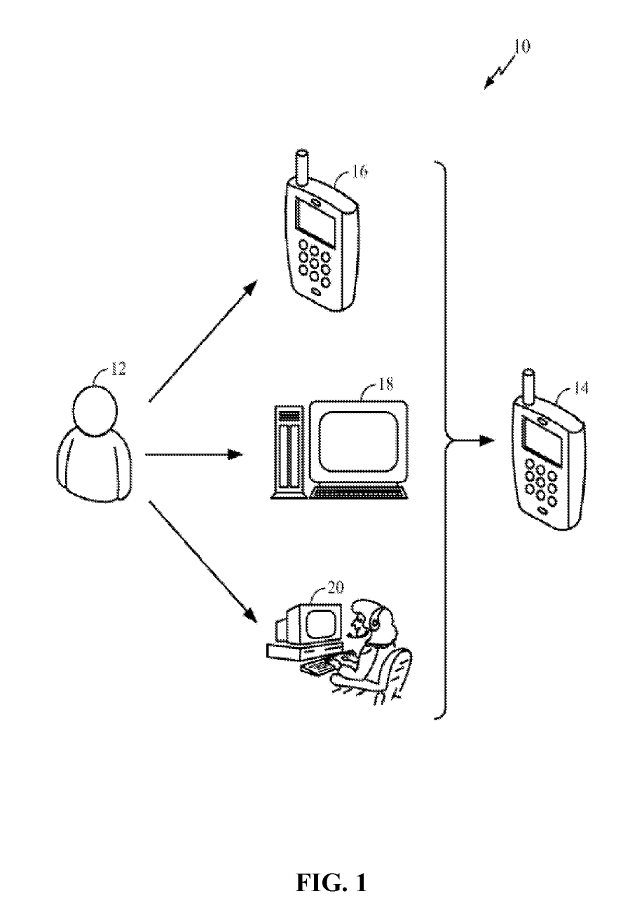

Referring to FIG. 1, a block diagram is depicted of a system 10 for remotely accessing a wireless communication device that has been misplaced, lost or stolen to initiate the locating, tracking and/or attempted recovery of present aspects. The user/owner 12 of the targeted wireless communication device 14, which may be categorized as misplaced device, a lost device, a stolen device or a device that requires tracking or surveillance, may remotely access the device 14 through various communication channels. The communication channels provide for generating and communicating a communication data packet, such as an SMS message or the like, which includes a locating state code for identifying one of a plurality of locating states (for example, a misplaced state, a lost state, a stolen state, a tracking state, a surveillance state, such as an emergency surveillance state or a covert surveillance state, and the like) that are operable on the targeted wireless communication device. As will be described at length infra., the locating states are associated with one or more predetermined location routines that are operable on the targeted wireless device. In many aspects, a locating state is associated with a predetermined sequence of routines or actions that are executed to locate, track, and attempt to recover the target device 14. In one aspect, a locating state may include a location state code which may enable at least one location functionality. As used herein, a location functionality may include, but is not limited to, any action performed to either directly or indirectly assist in location and/or recovery of the target device 14.

As shown in FIG. 1, the user/owner 12 may borrow or otherwise obtain an alternate or secondary wireless communication device 16 to generate and communicate the requisite communication data packet to the targeted device. In addition, the user/owner 12 may interface with a web interface through a PC 18, laptop (not shown in FIG. 1) or any other device having network access to the Internet. In such aspects, user/owner will provide necessary inputs to the web interface to initiate the generation and communication of the requisite communication data packet to the targeted device. In another aspect, user/owner 12 may communicate with a network/service provider entity 20 and the network/service provider entity may provide the necessary inputs to a network server to initiate the generation and communication of the requisite communication data packet to the targeted device. Alternatively, any other communication mechanism capable of generating and communicating the necessary communication data packet to the target device may also be used to initiate the location, tracking and attempted recovery process according to the present aspects.

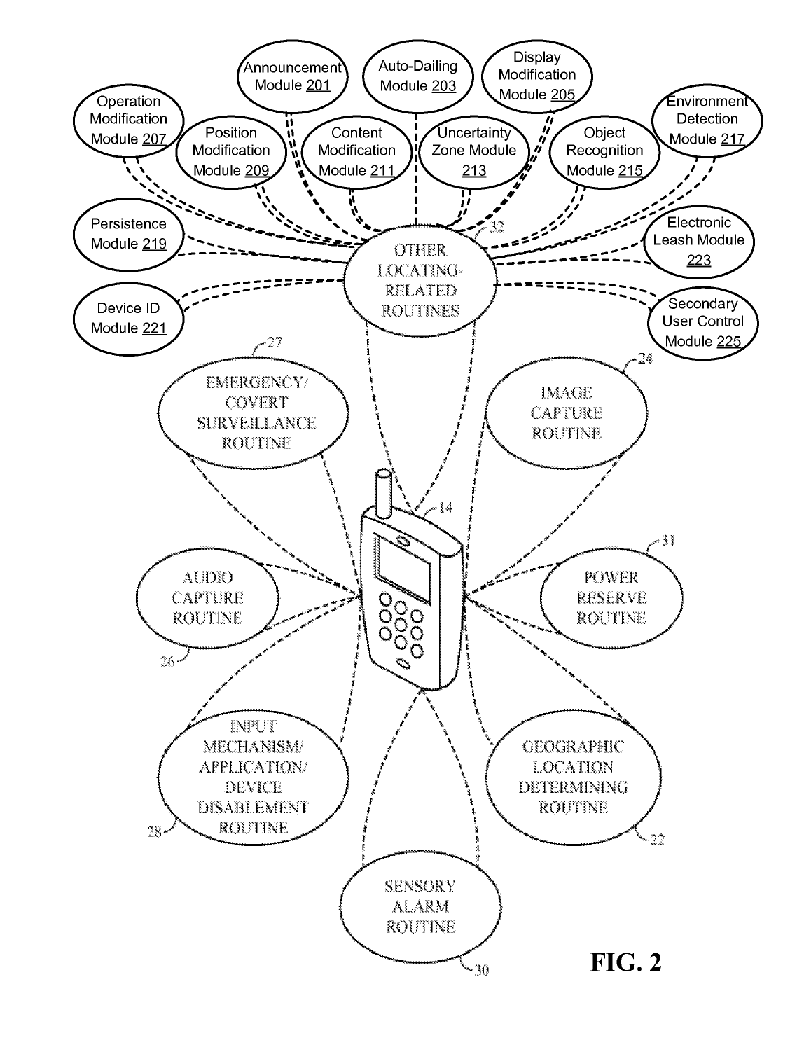

FIG. 2 provides a block diagram of various location routines that may be executed on the targeted wireless communication device 14 in response to detection of location state code in a received communication data packet. As previously noted, each location state will be associated with one or more location routines and, in some aspects, a location state will be associated with a sequence of location routines, such that detection of a location state code in a received communication data packet will trigger the execution of the sequence of location routines. As shown, in FIG. 2, the targeted wireless communication device may be operable to execute a geographic location determining routine 22, such as a Global Positioning System (GPS) location determining routine, a still or moving image capture routine 24 and/or an audio capture routine 26. The results of these routines, geographic location data, image data and/or audio data may then be communicated to back to the user/owner via the secondary device 16 and/or a web interface, a network entity, such as a service provider, a law enforcement entity and/or any other relevant entity for analysis. Geographic location data provides the ability to track the location of the misplaced, lost or stolen device. Image data, still or moving, and audio data may provide the ability to identify the finder/thief of the targeted device or identify the surrounding area in which the targeted device is located.

Additionally, target device 14 may be operable to execute emergency/covert surveillance routine 27 that provides surveillance of a location if an emergency event requiring surveillance occurs. For example, if a major accident occurs, such as an automobile accident, or a kidnapping/abduction occurs. The emergency/covert surveillance routine 27 may be operable to activate the still or moving image capture routine 24 to capture still or moving image data, the geographic location-determining routine 22 for determining location, the audio capture routine 26 for capturing audio and the like. Additionally, as shown in FIG. 2, the targeted device 14 may be operable to execute input mechanism, application and/or device disablement routine 28 that may operable to disable any input mechanism, such as the keypad, any application executable on the device, such as communication call applications or disable the device in its entirety. The targeted device 14 may also be operable to execute various forms of sensory alarm routines 30. Sensory alarm routines may trigger audible alarms, such as a series of periodic or continuous audible tones or a pre-recorded message, visual alarms, such as messages displayed on the target device display or vibrational alarms, which cause the device to vibrate periodically or continually. Sensory alarm routines serve to acknowledge to the general public that the device is misplaced, lost or stolen. The emergency/covert surveillance routine 27 may be operated when the emergency surveillance state is invoked or the emergency/covert surveillance routine 27 may be operated in a “stealth” mode when the covert surveillance state is invoked.

Additionally, the target device 14 may be operable to execute power reserve routine 32 that is operable maintaining a power reserve for the location, tracking and/or recovery process. For example, power may be reserved for determining location/GPS fixes, capturing image data and communicating with the remote communication device, such as a secondary wireless device, PC or network entity.

In addition, the target device 14 may be operable to execute any other locating, tracking, recovery and/or surveillance routine 32 that may be operable to assist in accomplishing recovery of the target device 14. For example, the other locating routine 32 may include a routine for changing an operational mode, such as changing the targeted device from a “silent”, “vibrate”, “airplane mode”, “low-volume”, or other new modes to an “audible” or “high volume” ring state, e.g. such as by changing a speaker or ring tone volume level (“maximum volume”), turning on an external speaker (“speaker phone mode”), etc. Often, the user of the targeted device will misplace the device while the device is in the “silent”, “vibration” or “low volume” ring state. These states prohibit the device from being located by merely calling the device and listening for the ring tone. In addition, in certain instances it may be necessary to change the misplaced targeted device from an “off” state to an “on” state prior to changing the ring tone state or performing other locating routines on the targeted wireless device. Other locating, tracking, recovery and surveillance routines 32 may include routines operable for jamming, scrambling or otherwise corrupting the communication data, such as voice data, text data, image data or the like.

In one aspect, other locating-related routine 32 may include a announcement module 201 for making audio announcements (e.g. a pre-recorded message, a ring-tone, etc.) even if the wireless device is functioning in a ‘vibrate’ or ‘silent’ or ‘off’ mode of operation. In one aspect, the announcement module 201 may automatically increase volume and/or turn on the speaker-phone to make audio announcements. In another aspect, the wireless device may be made apparent to people nearby. Furthermore, in such an aspect, any audio announcement may announce return recovery messages such as but not limited to, a “call home” request, a request to contact a third party, or any announcement of return instructions, mailing instructions (e.g. mailing address and account number to use to charge mailing fees) or a telephone number to call, etc. Still further, in such an aspect, any audio announcement may announce a warning that the wireless device is being tracked, or authorities have been notified, etc. Even further, in one aspect, the announcement module 201 may prompt the wireless device to phone announce and/or display a message, such as a pre-recorded audio clip and/or graphic, describing one or more of the actions the phone is about to perform, such as taking photos, recording audio, video, etc., prior to taking such actions. In another aspect, audio announcements may further announce that the wireless device is being disabled, or can not make calls, etc. In one aspect, once an announcement is performed, the wireless device may be obtained by a searching entity such as but limited to, the owner/user, a third party, etc. In such an aspect, the wireless device may be obtained by being returned or retrieved by a searching entity. In the aspect in which a third party obtains the wireless device, the third party may then return the wireless device to the owner. The returning may be performed directly, through postage, etc. Further an owner may be located through any number of identifying characteristics, such as, a phone number, an address, an account number, etc.

In one aspect, other locating-related routine 32 may include an auto-dialing module 203 for enabling one or more auto dialing presets. In such an aspect, the auto-dialing module 203 may include one or more autodial presets which may include but are not limited to, a “call home” preset that enables the device to call a predefined “home” location, such as another number registered to the wireless device user, a call center able to handle returns of the device, etc. In such an aspect, the one or more auto-dialing presets may be presented more prominently on the wireless device display than when such presets are presented, if at all, when the routine is not enabled.

In one aspect, other locating-related routine 32 may include a display modification module 205 for continuously, intermittently and/or periodically modifying the wireless device display state. For example, a wireless device may modify its display by blanking out the display, changing a radio frequency (RF) signal strength indicator to falsely display a reduced value, changing a battery indicator to falsely display a reduced value, etc. In another example, a wireless device may change the display screen color, intensity and/or cause the screen to flash so as to more readily facilitate locating the wireless device or to give the impression that the display screen is not working properly in order to discourage unauthorized use, e.g. triggered by an attempted usage of the device when this routine is active. As such, in the display modification module 205, the device may provide a false sense of low or faulty performance, thereby discouraging any attempted unauthorized usage of the device.

In another aspect, other locating-related routine 32 may include a operation modification module 207 for continuously, intermittently and/or periodically modifying at least one wireless device operational state. For example, upon activation of the operation modification module 207, the wireless device may power down, loop between power down/up, etc. so as to frustrate any attempted unauthorized usage of the wireless device. In another example, upon activation of the operation modification module 207, the wireless device may periodically disable the RF transceiver. The operation modification module 207 may be triggered by attempted unauthorized usage of the device while this routine is activated. In another aspect, the wireless device may shield, encrypt, delete or otherwise protect data stored on the wireless device. In such an aspect, the wireless device may transmit at least a portion of user generated content (e.g. contacts, passwords, audio, photos, videos, applications, etc.) and purge the wireless device thereafter.

In another aspect, other locating-related routine 32 may include a position modification module 209 for continuously, intermittently and/or periodically modifying the wireless device physical positioning. For example, the position modification module 209 may include instructions configured to cause a camera associated with the wireless device to move, rotate, or be manipulated in some manner so as to provide an image, video, etc. of the surroundings. In one aspect, the wireless device may vibrate, flip, move in a specific direction, etc., in response to a variety of conditions. For example, a camera associated with the wireless device may be facing down or in a direction that does not assist in location. In such an example, the wireless device may attempt to adjust its physical positioning so as to more readily facilitate locating the wireless device. In another example, the device may include an actuator connected to an arm, such as a flip portion of the device, and activation of the position modification module 209 may energize actuator to automatically move flip portion, for example, in an effort to change a position of the device, e.g. to change a side of the device including the camera from facing down to facing up or facing sideways. In another example, if an image taken is “black” (e.g. camera is covered or lying face down on ground), the target WCD may activate the position modification module 209. In such an example, a “black” image may be defined as where a majority of pixels in a digital image are black or off.

In one aspect, other locating-related routine 32 may include an uncertainty zone module 213 for determining an “uncertainty zone.” As used with respect to this aspect, an uncertainty zone may be defined as a geographic region of defined dimensions within which the exact location of the wireless device may not be determined. For example, GPS aided tracking of the wireless device may provide specific latitude and longitude coordinates, however, there may be a degree of uncertainty with respect to such coordinates, e.g. based on the precision of the system or based on lack of some coordinates. For example, latitude and longitude coordinates may correspond to a high rise building, and the uncertainty zone may include at least a portion of the high-rise building, e.g. such as a floor within the building when the GPS information does not include an altitude. In another example, specified latitude and longitude coordinates may be provided although a device being used to find those coordinates may not be able to exactly determine its own location. In such an instance, the uncertainty zone may be defined by the searching device locational accuracy. In one aspect, the wireless device may transmit location information to aid in determining an uncertainty zone. In such an aspect, the uncertainty zone may be displayed on a searching device, a computing device, to a monitoring third party, etc. Such display may enable a wireless device to be more easily located and/or retrieved, e.g. by representing the uncertainty zone on a map.

In one aspect, the uncertainty zone module 213 may enable functions on the wireless device to operate differently once a searching entity is within a predefined vicinity of the uncertainty zone. For example, the wireless device may activate an announcement or other audible noise, e.g. a loud alarm, to aid in finding the wireless device once a searching entity is within a predefined vicinity of the uncertainty zone. In another example, the wireless device may activate additional device functionalities once a searching entity is within a predefined vicinity of the uncertainty zone, such as but not limited to, taking a picture, recording an audio clip, recording a video clip, or any other functionality that may assist the searching entity in locating the wireless device within the uncertainty zone. In yet another example, the wireless device may activate still additional device functionalities once a searching entity is within a predefined vicinity of the uncertainty zone, such as but not limited to, establishing a communication link with the searching entity through, Bluetooth, a WLAN, etc. In still another example, if a communication link is established with the searching entity, the wireless device may “ping” the searching device to provide directional assistance for wireless device location within the uncertainty zone. Such a “ping” may include one or more IP messages to the searching entity with one or more IP messages in return from the searching entity to assist in determining a relative distance and/or a direction to the misplaced device. For example, the “ping” may trigger the searching device to generate an audible and/or graphic output to provide the searching entity with feedback on their progress in locating the misplaced device, e.g. to dynamically update the uncertainty zone. For example, the audible and/or graphic output may represent a “getting hotter” or “getting colder” indication, e.g. such as increasingly frequent beeping when the searching device is moving nearer to the misplaced device or a decreasingly frequent beeping when the searching device is moving further away. As such, the uncertainty zone module 213 may allow the searching device to zero-in on the location of the misplaced wireless device within the uncertainty zone. In another example, a searching entity may include an entity using a WLAN based technology which may allow the entity to attempt to communicate with a target device which may be within the coverage region of the WLAN. In such an exemplary, upon a determination that the target device is which the coverage region, the searching entity may communicate at least one of: the search entity location, the coverage region location, a target device identifier, etc., to a user and/or another searching entity.

In another aspect, upon detection by the target device that a searching entity is not a known and/or authorized searching entity, the device may give scrambled location, wrong indications, etc. In other words, the target device provides the unauthorized searching entity with false information leading away from or attempting to prevent the discovery of the target device. Further the target device may notify a network server of the attempted searching by an unknown and/or unauthorized entity. As such, the target device may protect itself from discovery by unauthorized searching entities.

In another aspect, other locating-related routine 32 may include a object recognition module 215 for object recognition. In such an aspect, the object recognition module 215 may allow the wireless device to detect recognized faces, gestures, objects, etc. Such information may be used to facilitate finding the wireless device. In one aspect, the object recognition module 215 may trigger additional functionalities upon recognition of certain gestures or faces. For example, the device may automatically return to a normal functioning mode upon recognition of the rightful owner/user or some other authorized user. In another example, the wireless device may transmit images to a network upon recognition that the images are faces, and such images may be used to identify the location or person in the image.

In one aspect, other locating-related routine 32 may include an environment detection module 217 for detecting environmental change associated with the wireless device. In one aspect, motion may be detected by an associated accelerometer or GPS functionality. In other aspects, a change in one or more other environmental conditions may include, but are not limited to, a change in detected light, a change in detected temperature, a change in detected smells or scents, a change in vibrations, a change in ambient noise level, a change in pressure, etc. For example, such changes may be detected by corresponding sensors coupled to the wireless device. Upon detection, e.g. either a relative change or a change reaching a given threshold, the environment detection module 217 may further prompt the wireless device to perform one or more additional functionalities. For example, upon detection of movement, the wireless device may: record audio and/or video clips for a predetermined duration, etc., and may transmit such data to a searching entity. As such, the wireless device may actively participate in attempting to be returned to its rightful owner by at least detecting changes in its own environment.

In one aspect, other locating-related routine 32 may include a persistence module 219 for persistently remaining active through battery, hardware, firmware, software etc., changes to the wireless device. For example, the state of the persistence module 219 may be preserved even though the wireless device battery has been removed, e.g. by saving the state of the routine in persistent memory such that the routine may continue where it left off when a battery is re-installed or power is applied. In one aspect, the persistence module 219 may prompt the target wireless device to attempt to preserve battery usage by shutting down unwanted circuitry, applying power-save algorithms, while periodically sending out the target device current location, time, surrounding environment information, etc., based on sensors such as temperature, noise, pressure, etc.

In one aspect, other locating-related routine 32 may include a routine for retaining emergency contact functionality. In such an aspect, the wireless device may allow interactions with emergency services, or other services required by laws applicable where the device may be currently situated. For example, the device may allow calls to an emergency service, e.g. a “911” call, to be transmitted irrespective of the current status of the wireless device with respect to its rightful owner.

In one aspect, other locating-related routine 32 may include a device identification module 221 for facilitating usage of wireless device specific identifying information relating to hardware, firmware, software, etc. in location detection. For example, wireless device specific identifying information may include an R-UIM card, a SIM card, a virtual R-UIM and/or SIM, etc. In one aspect, the device identification module 221 may detect the replacement of SIM/R-UIM card or virtual R-UIM/SIM by running in the background and using the corresponding MIN information (Mobile Identification Number), or any other reliable data, such as previously extracted information from the R-UIM, etc., that identifies the SIM/R-UIM card or virtual R-UIM/SIM, for comparison with corresponding stored, authorized information. As such, the device identification module 221 may maintain a trusted set of wireless device specific identifying information for use in validation and authorization checks. In one aspect, if the information associated with the replacement SIM/R-UIM card or virtual R-UIM/SIM is properly verified against the trusted set, then the device identification module 221 may not get invoked and the wireless device may maintain a normal functioning mode. However, when a foreign or unauthorized SIM/R-UIM card or virtual R-UIM/SIM (not in the set) is inserted and detected, the routine may lock the wireless device from further usage and/or trigger one or more of the device locating, tracking and recovering routines discussed herein. In one aspect, if the foreign wireless device specific identifying information, such as SIM/R-UIM card or virtual R-UIM/SIM, etc., is from a predefined set, the routine may allow for additional functionalities to be enabled. For example, if a foreign R-UIM card is recognized, the wireless device may completely purge any personal identifying information. Further, the device identification module 221 may upload the foreign identifying information to a network server. Such uploading may allow a service provider to be aware of the usage by the foreign SIM/R-UIM card or virtual R-UIM/SIM.

In another aspect, the device identification module 221 may allow an authorized owner/user to manage (e.g. add, delete, etc.) the above mentioned set of wireless device specific identifying information, such as R-UIM card, SIM card, virtual R-UIM/SIM, etc. In such an aspect, the set may be automatically populated with wireless device specific identifications registered to the authorized owner/user. In another aspect, the device identification module 221 may prompt the authorized owner/user to populate the set the first time the routine is run and/or periodically thereafter.

In another aspect, the device identification module 221 may allow an owner/user to switch between an active routine mode and a normal wireless device mode using a code, such as a personal identification number (PIN), etc., in case of accidental insertion of an unlisted SIM/R-UIM card or virtual R-UIM/SIM. In another aspect, the wireless device specific identifying information may include virtual wireless device specific identifying information stored in firmware or software.

In another aspect, other locating-related routine 32 may include an electronic leash module 223 for electronic leash functionality. In such an instance, the electronic leash module 223 may detect the relative wireless device location with respect to one or more second items. In one aspect, the second item may include an access badge, a wallet, a set of keys, a purse, or any other item that a person may typically carry with them, etc. Accordingly, in the event that the wireless device travels a predefined distance away from the second item, the routine may be enabled and functionality for the wireless device may be modified. For example, if a wireless device is taken too far from a second item, such as an access badge or a set of keys, the phone would cease to work. Additionally, or in the alternative, if a relative distance between the wireless device and any of the second items is greater than a predetermined threshold, such as if the wireless device or one of the second items was left behind, then the wireless device may alert the user through a beep or some other form of alert so the user is aware that the wireless device or item was left behind. Further, the alert may notify the user specifically which item or items were left behind and/or notify the user to come back and collect the item or items. Additionally, or in the alternative, multiple devices or items may be electronically leashed together in such a manner that movement of one or more of the devices or items of a predetermined distance from one or more of the other leashed devices or items would result in activation of an alert.

In another aspect, the environment module 217 may be operable for movement tracking In such an instance, the wireless device routine may track its position, through satellite-based location information, e.g. GPS, or terrestrial-based networks, etc., and/or may measure forces applied to the device, e.g. through pressure sensors and/or accelerometers mounted in the device. For example, driving habits may be determined through a location system, e.g. GPS, providing average speed, top speed, etc., and the forces detected by the device, such as by an accelerometer, through changes in vibrations, etc., providing a maximum detected acceleration the device withstood.

In another aspect, the environment module 217 may further notify an owner/user of entrance into a predefined area of interest, such as a high crime area, a specific neighborhood, etc. In one aspect, the high crime area may be determined through analysis of other reported wireless device thefts by similar routines functioning on other wireless devices, by tying into a crime hotspots database, etc. Alternatively, the area of interest may be defined by an authorized user of the device. In another aspect, upon entry into the area of interest, the environment module 217 may prompt the wireless device to be in a mode in which emergency services are readily accessible via the wireless device. For example, when entering a high crime area, the environment module 217 may display a virtual button option that is preprogrammed for calling 911. In another example, an area of interest routine may be used in conjunction with a tour service to notify the participants of specific locations and/or events of interest.

In another aspect, the environment module 217 may further automatically launch an application in response to a triggering event. In one aspect, such a triggering event may include, but is not limited to, one or more of a predefined geographic location, a time, an external alarm, a voice command, etc. For example, the routine may auto launch traffic update information upon a determination that the device is within an automobile, driving on a road, or the like.

In another aspect, the announcement module 201 may further include a community notification function. In such an aspect, the wireless device may notify other devices within a predefined vicinity of the presence of the target wireless device. In one aspect, the announcement module 201 may assist a contacted other device within the vicinity in recovering the target device, such as through use of the uncertainty zone functionalities described above. In another aspect, the announcement module 201 may receive information from devices within predefined vicinity. For example, the announcement module 201 may receive information such as a notification for and location of an open parking space in a parking garage.

In another aspect, the operation modification module 207 may include an idle operation modification function. In such an aspect, an alarm indicator may activate after certain predefined duration if the wireless device is switched-off. Further, the target device may send a message to another predefined phone number specifying information associated with the target device, such as its location, whether the device still has a SIM or R-UIM card, etc.

In another aspect, the operation modification module 207 may include a recovery service function. In such an aspect, when the target WCD is lost or stolen, and a user accesses a recovery service, the user may be warned that if the service is initiated, the target WCD may be at least partially locked. Further a user may be informed a payment may be required in order to unlock the target WCD if or when it is recovered. Further, when initiating the recovery service (e.g. locking the device and beginning to locate it) a user authentication step may be performed. In one aspect, the authentication may include using a password that is specific to the recovery service. Optionally, a credit card or other payment instrument (e.g. account and password information) can be used as the authentication method, rather than using a password that is specific to the recovery service. Still further, if payment instrument are not used as the authentication method to initiate the service, then a payment instrument may be asked for from the user at some point prior to unlocking the handset. The payment could be presented by the user through any access method, including a web site, or providing the payment information over the phone to a person in a call center, or it could be entered at the handset when the handset is found, etc. In one such an aspect, the target WCD allow a user to access a routine for entering payment information even when the target WCD is locked. The payment information may be obtained from the user at any time prior to unlocking the handset. If the payment for unlocking the handset is obtained from the user through a means other than the handset, which implies that the user may not yet be in possession of the handset, then an “unlock” code may be issued to the user. The unlock code can then used to unlock the handset when it is in the possession of the user. Additionally, or optionally, if the payment information is entered through an input on the target WCD, which implies that the user is in possession of the target WCD, then the handset may be unlocked at that time without issuing an unlock code.

In another aspect, other locating-related routine 32 may include a secondary user control module 225 for parent control, etc. In such an aspect, a wireless device may be disabled at specific locations (e.g. school, church, etc.) stored in the device by an authorized user, e.g. a parent. Further, the secondary user control module 225 may provide for prompting the wireless device to transmit information to allow a web-based interface to control at least a portion of data/voice interactions with one or more other defined wireless devices. For example, specific web content may be restricted and/or specific phone numbers may be blocked. Still further, the secondary user control module 225 may allow for detection of whether specific locations have been visited, and/or the timing associated with such visits. For example, the secondary user control module 225 may determine if the device (and presumably the child) visited a library or a mall after school, or if the child left the service coverage area. In another aspect, the secondary user control module 225 may be used to remotely disable at least a portion of the functionalities of an associated wireless device. In another aspect, the secondary user control module 225 may prompt the wireless device to sense activities of associated devices, such as ignition of an automobile, opening/closing of doors or windows, e.g. in a car or in a house, diagnostics of an associated automobile, etc. Further, in another aspect, the secondary user control module 225 may preserve an amount of power to send a message triggered by a shutdown of the device, for example, where the message may provide location information and/or direction and/or speed of movement of the device at the time of the power down. Such a message may be provided to a predetermined party, such a phone or computer of a parent, e.g. via an e-mail or text message.

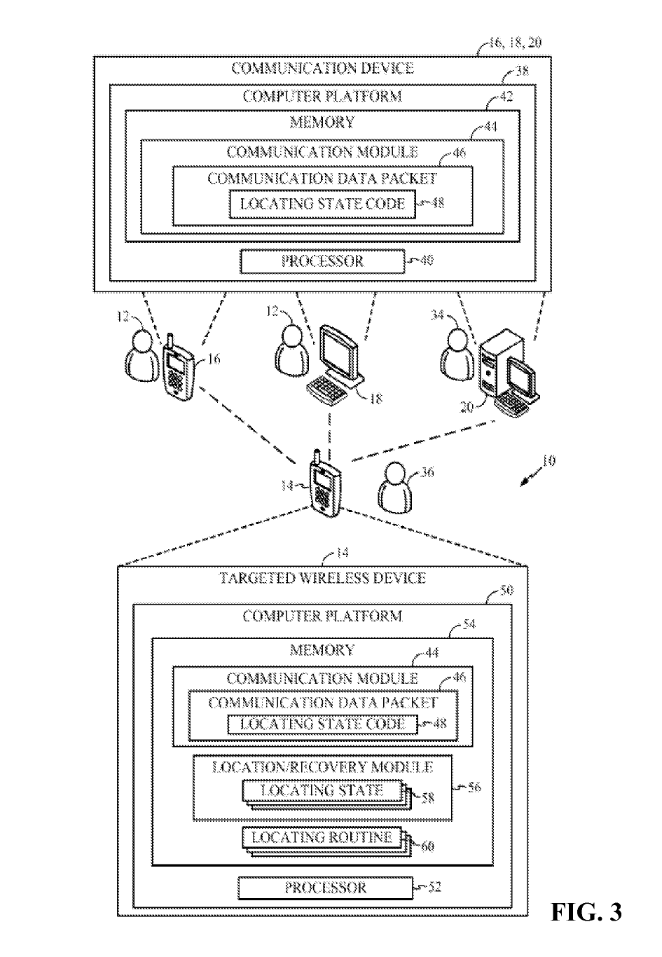

Referring to FIG. 3, a block diagram is depicted of the system 10 for locating, tracking and attempting recovery of a target wireless communication device 14. As previous discussed, a remote computing device is employed to generate and communicate the requisite communication data packet to the target device 14. The remote device may include, but is not limited to, an alternate or secondary wireless device 16 in the possession of the user/owner 12 of the targeted device, a PC 18 accessible to the user/owner 12 and having access to a web interface operable for generating and communicating the requisite communication data packet and a network entity device 20 operated by network/service provider representative 34. The target device 14, which may be in the possession of finder/thief 36, receives the communication data packet detects the locating state code in the communication that is associated with a locating state and executes one or more locating routines associated with the locating state.

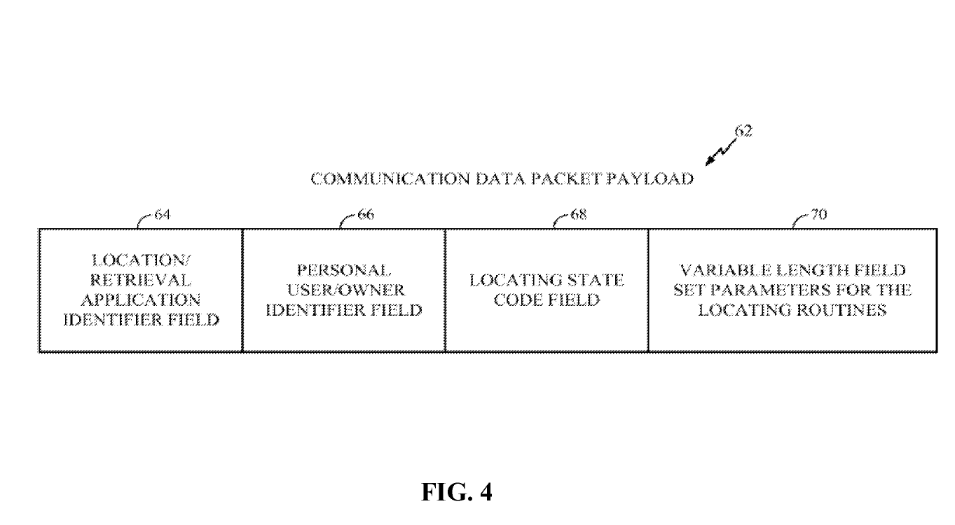

The remote computing device 16, 18, 20 includes a computer platform 38 having a processor 40 and a memory 42. The memory includes a communications module 44 operable for generating and communicating communication data packet 46, which may correspond to a voice call packet or a data call packet. In one aspect, communication data packet 46 is defined as a Short Message Service (SMS) data packet. FIG. 4, which will be discussed in detail infra., provides for an exemplary payload for an SMS data packet, according to an aspect. The communication data packet 46 will include a locating state code 48 that is associated with one of a plurality of locating states, which are operable on the target device 14. Each locating state being associated with one or more predetermined location routines that are executable on the target devices 14.

The targeted wireless communication device 14 includes a computer platform 50 having a processor 52 and a memory 54. The memory includes communications module 44 operable for receiving communication data packet 46, which, as previously discussed, may correspond to a voice call packet or a data call packet. In one aspect, communication data packet 46 is defined as a Short Message Service (SMS) data packet. The communication module 44 is operable to parse the locating state code 48 from the communication data packet 46 and communicate the locating state code 48 to the location/recovery module 56. The location/recovery module is operable for matching the locating state code 48 to an associated locating state 58 and triggering the execution of the locating routines 60 that are associated with the locating state. Examples of locating states include, but are not limited to, a misplaced state, a lost state, a stolen state, a tracking state, a surveillance state, such as an emergency surveillance state or a covert surveillance state, and the like. Additionally, each state may include sub-states for varying the routines associated with a state or varying the sequence in which routines are executed. As previously noted, each location state is associated with one or more location routines and, in some aspects; the location state may be associated with a predetermined sequence of routines. Examples, of location routines include, but are not limited to, an input mechanism disablement routine, an application disablement routine, a device enablement/disablement routine, a device state change routine, such as a ring state change routine, a geographic location determining routine, a still image capture routine, a moving image capture routine, an audio capture routine, a sensory alarm routine, a user data retrieval routine, a user data deletion routine, a user data lockdown routine, a captured data upload routine and the like.

Referring to FIG. 4, an exemplary payload 62 of a SMS communication data packet is shown. As previously discussed SMS may be used as the communication module 44 for communicating the requisite communication data packet 46 from the remote device 16, 18 or 20 to the target device 14. The payload may include a location/retrieval application identifier filed 64 operable for identifying the payload, upon receipt by the target device, as being associated with the locating/retrieval application. The payload 62 may additionally includes personal user/owner identifier field 66 operable for identifying the user 12, network/service provider representative 34 or the like as an authorized entity for implementing the location/recovery application on the target device 14. In this regard, authentication insures that the target device is not placed in a locating state by an unauthorized individual or entity. The payload 62 may additional includes a locating state code field 68 operable for identifying the locating state that is to be operational on the target device 14.

The payload 62 of SMS communication data packet 46 may include a variable length field 70 operable for setting parameters for the one or more routines that are associated with the locating state. For example, parameter settings may include the frequency required for location determinations, the frequency at which images or audio are captured, the memory location of data that is required to be deleted, an audible message to be produced, a visual message to be displayed or the like. In this regard, the variable length field 70 provides for the parameters related to the location routine to be dynamically defined by the user/owner and/or network service provider based on the current requirements dictated by the user/owner and/or network service provider.

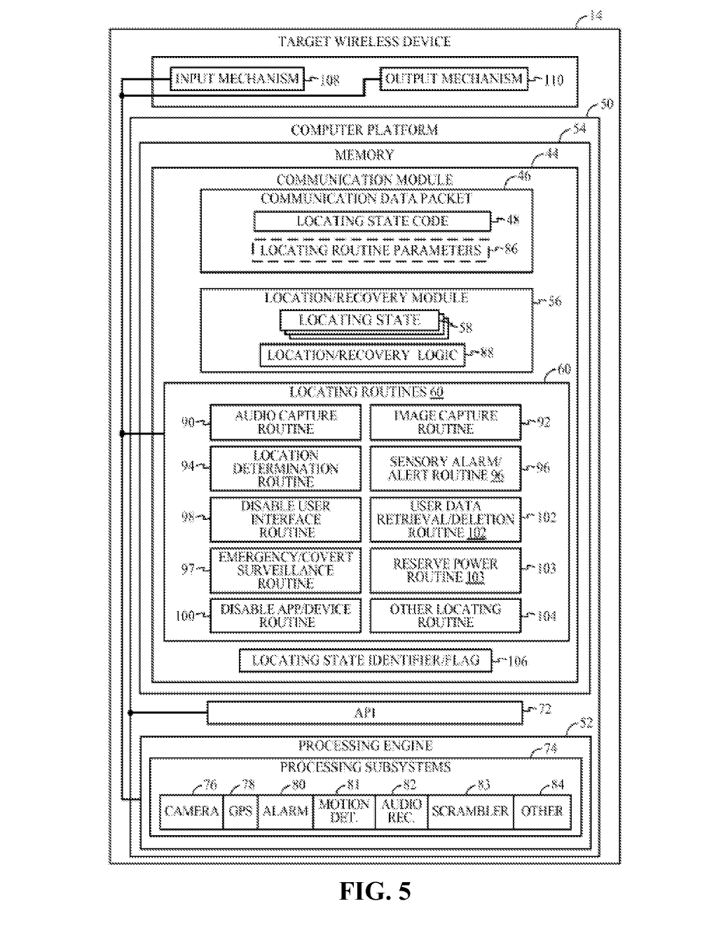

Referring to FIG. 5, according to one aspect, a detailed block diagram representation of targeted wireless communication device 14 is depicted. The wireless communication device 14 may include any type of computerized, communication device, such as cellular telephone, Personal Digital Assistant (PDA), two-way text pager, portable computer, and even a separate computer platform that has a wireless communications portal, and which also may have a wired connection to a network or the Internet. The wireless communication device can be a remote-slave, or other device that does not have an end-user thereof but simply communicates data across the wireless network, such as remote sensors, diagnostic tools, data relays, and the like. The present apparatus and methods for sharing locating and attempting recovery of a wireless communication device can accordingly be performed on any form of wireless communication device or wireless computer module, including a wireless communication portal, including without limitation, wireless modems, PCMCIA cards, access terminals, desktop computers or any combination or sub-combination thereof.

The wireless communication device 14 includes computer platform 50 that can transmit data across a wireless network, and that can receive and execute routines and applications. Computer platform 50 includes memory 54, which may comprise volatile and nonvolatile memory such as read-only and/or random-access memory (RAM and ROM), EPROM, EEPROM, flash cards, or any memory common to computer platforms. Further, memory 54 may include one or more flash memory cells, or may be any secondary or tertiary storage device, such as magnetic media, optical media, tape, or soft or hard disk.

Further, computer platform 50 also includes processor 52, which may be an application-specific integrated circuit (“ASIC”), or other chipset, processor, logic circuit, or other data processing device. Processor 52 or other processor such as ASIC may execute an application programming interface (“API”) layer 72 that interfaces with any resident programs, such as communication module 44 and location/recovery module 56, stored in the memory 54 of target wireless device 54. API 72 is typically a runtime environment executing on the respective wireless device. One such runtime environment is Binary Runtime Environment for Wireless™. (BREW™) software developed by Qualcomm, Inc., of San Diego, Calif. Other runtime environments may be utilized that, for example, operate to control the execution of applications on wireless computing devices. In some aspects, API 72 may serve to launch the location routines 60 upon receipt of the communication data packet 46, detection of the accompanying locating state code 48 and determination of the associated locating state 58. Alternatively, one or more of the location routines may be in an “always-on” state, running in the background on the target device 14, otherwise referred to as a “silent mode” and are awaiting receipt of the communication data packet 46, detection of the accompanying locating state code 48 and determination of the associated locating state 58 prior to moving to an active state that captures data, activates an alarm or performs another location related action.

Processor 52 includes various processing subsystems 74 embodied in hardware, firmware, software, and combinations thereof, that enable the functionality of communication device 14 and the operability of the communication device on a wireless network. For example, processing subsystems 74 allow for initiating and maintaining communications, and exchanging data, with other networked devices. In aspects in which the communication device is defined as a cellular telephone the communications processor 52 may additionally include one or a combination of processing subsystems 74, such as: sound, non-volatile memory, file system, transmit, receive, searcher, layer 1, layer 2, layer 3, main control, remote procedure, handset, power management, digital signal processor, messaging, call manager, Bluetooth™ system, Bluetooth™. LPOS, position engine, user interface, sleep, data services, security, authentication, USIM/SIM, R-UIM, Virtual SIM, voice services, graphics, USB, multimedia such as MPEG, GPRS, etc (all of which are not individually depicted in FIG. 2 for the sake of clarity).

For the disclosed aspects, processing subsystems 74 of processor 52 may include any subsystem components that interact with the communication module 46 and location/recovery module 56. For example, processing subsystems 74 may include locating and tracking devices/applications that are implemented in conjunction with locating routines 60. Exemplary processing subsystems 74 may include imager/camera 76, Global Positioning System (GPS) sensor 78, alarm 80, motion detector 81, audio recorder 82, scrambler 83 and any other apparatus 84 that is implemented in relation to a locating routine 60. Alternatively, one or more of the processing subsystems 74 shown in FIG. 4 may exist as modules/applications and/or logic stored in memory 54.

The memory 54 of computer platform 50 includes communications module 44 operable for receiving communication data packet 46, which, as previously discussed, may correspond to a voice call packet or a data call packet. In one aspect, communication data packet 46 is defined as a Short Message Service (SMS) data packet. The communication module 46 is operable to identify the communication data packet, based on payload identification, as being a location/recovery communication data packet. Additionally, the communication module 46 is operable to authenticate the sender of the communication data packet based on an authentication identifier in the payload. The communication module 44 is operable to parse the locating state code 48 from the communication data packet 46 and communicate the locating state code 48 to the location/recovery module 56. Additionally, communication module 44 may be operable to parse the variable length field that includes locating routine parameters 86 and communicate the locating routine parameters to the location/recovery module 56.

The memory of computer platform 50 also includes location/recovery module 56 that includes location/recovery logic 88 operable to match the locating state code 48 to one of a plurality of locating states The location/recovery module is operable for matching the locating state code 48 to an associated locating state 58 and triggering the execution of the locating routines 60 that are associated with the locating state. Examples of locating states include, but are not limited to, a misplaced state, a lost state, a stolen state, a tracking state, a surveillance state, such as an emergency surveillance state or covert surveillance state, and the like. Additionally, each state may include sub-states, for example, a major lost state and a minor lost state, for varying the routines associated with a state or varying the sequence in which routines are executed. The location/recovery logic 88 may also be operable for applying the locating routine parameters 86 to the applicable location routine 60.

Additionally, location/recovery logic 88 may be operable to place a locating state identifier/flag 106 in a non-volatile portion of memory 54 to identify the current location state 58 that the target device is experiencing. By placing locating state identifier/flag 106 in non-volatile memory, the device is insured of returning to the current location state 58 if the device temporarily loses power (for example, if the battery is removed), followed by the subsequent restoration of power. The locating state identifier/flag 106 may define an associated expiration parameter that dictates removal of the identifier/flag from the memory after a stated period of time or an additional communication data packet 46 may be received that provides for the termination of a locating state 58 and the deletion of the identifier/flag 106 from memory 54.

The memory of 24 of computer platform 20 also includes a one or more location routines 60 that are associated with one or more of the plurality of locating states 58. As shown, location routines 60 may include, but are not limited to, audio capture routine 90, image capture routine 92, location determination routine 94, sensory alarm/alert routine 96, emergency/covert surveillance routine 97, user interface disablement routine 98, application/device disablement routine 100, user data lockdown/retrieval/deletion routine 102, reserve power routine 103, and any other locating-related routine 104. The audio capture routine 90 and the image capture routine 92 are operable to record audio and still and/or moving images periodically or based on the occurrence of an event, for example a call event. The audio and image data may subsequently be used to determine the identity of the finder/thief of the wireless device or identify the location of the device based on the surrounding environment. The location determination routine 94 is operable to determine a geographic location of the target device 14 using GPS sensors or any other conventional means of determining geographic location. Captured image and/or audio data and geographic location data may be periodically updated to the user/owner 12 of the target device 14 via the secondary wireless device 16 and/or a web interface, a network entity 18, such as a server associated with a web interface and/or a network/service provider representative 20 for subsequent analysis for attempting to determine the location of the lost/stolen device and/or the identity of the finder/thief. Additionally, the audio capture routine 90, the image capture routine 92 and the location determination routine 94 may be executed in a “stealth” mode, so that conventional indicators that would normally be presented, such as displayed lights or messages or audible tones, are suppressed to insure that the finder/thief is unaware that these routines are currently being executed. The “stealth” mode may be the mode of choice for a covert surveillance state.

The sensory alarm/alert routine 96 may be operable to provide audible, visual or vibrational alarms on the device. For example, an audible alarm may be provided periodically continually and/or at an increasing volume to identify the device as a misplaced, lost or stolen device. The audible alarm may also be configured to present an audible voice message that may be defined within the routine or may the voice message may be provided to the routine dynamically via the variable length field in the communication data packet. In another aspect, the alarm/alert routine 96 may be configured to provide a visual alarm or message that may be displayed on the device. The message that is displayed may be defined within the routine or the message may be provided to the routine dynamically via the variable length field in the communication data packet. For example, in one aspect, if the device is lost—user contact information may be displayed for contacting the user/owner of the device or a self-addressed or network service provider-addressed shipping label with pre-postage may be displayed to allow the finder of the device to conveniently place the device in a postal box for delivery to the user/owner 12 or service provider. In other aspects, the alarm/alert routine 96 may be configured to vibrate the device, either periodically or continually, to alert the finder/thief that the device is misplaced, lost or stolen.

The emergency/covert surveillance routine 97 is operable to provide surveillance of a location if an emergency event requiring surveillance occurs. For example, if a major accident occurs, such as an automobile accident, or a kidnapping/abduction occurs. In these instances, a targeted wireless communication device 14 in the possession of an accident/kidnapping victim or someone close to the accident/kidnapping may be remotely accessed via a secondary wireless device 16, PC 18 and/or network device 20 in the control of a law enforcement entity, an emergency service provider or any other person/entity concerned with the safety and welfare of the victims. Additionally, other remote devices may signal the targeted wireless device 14 for initiating the surveillance routine 97. For example, air bags in an automobile may be configured to send, upon deployment, a wireless signal to the targeted wireless communication device 14 to activate the surveillance routine 97. In addition, the targeted wireless communication device 14 may be configured to self-activate the emergency/covert surveillance routine 97, if a predetermined event occurs, such as placement of an emergency call (e.g. a “911” call) or detection of impact of an automobile accident (based on a motion detector 81 processing subsystem in the targeted wireless device 14).

The emergency/covert surveillance routine 97 may be operable to activate the still or moving image capture routine 24 to capture still or moving image data, the geographic location-determining routine 22 for determining location, the audio capture routine 26 for capturing audio and the like. In certain aspects, the remote surveillance requesting party, such as a law enforcement agency, emergency service provider or the like may have the ability to remotely control the surveillance mechanisms once they are activated. For example, the surveillance requesting party may be able to provide inputs to a user interface to remotely access and control the image capturing devices, such as controlling movement and direction of the image capturing device and the like. Once the information is captured, it may be wirelessly communicated to the requesting entity or any other law enforcement entity, emergency service provider or the like. In a kidnapping event or any other event involving a criminal party, the surveillance routine 97 may be operated in a “stealth” mode, so that conventional indicators that would normally be presented, such as displayed lights or messages or audible tones, are suppressed to insure that the kidnapper/criminal is unaware that these routines are currently being executed. For example, if the location state is defined as a covert surveillance state, the surveillance routine 97 may be operated in the “stealth” mode to elude the perception of surveillance from wrongdoers.

The user interface disablement routine 98 and the application/device disablement routine 100 are operable to disable a user input mechanism 108 or output mechanism 108, such as the keypad or touch screen of the target device, any application that is executable on the device, such as communication call application, a contact/phone book application and/or the like, or disable the device in its entirety. The user interfaces, applications and/or the device may be disabled permanently or disabled periodically to allow for the device to periodically capture data, such as image and/or audio data, determine location and upload the data accordingly.

The user data lockdown/retrieval/deletion routine 102 may be operable to lockdown the user data to prohibit a finder/thief from accessing any or all of the user data. The user data retrieval/deletion routine 102 may also be operable to retrieve the user data from the device, communicate the retrieved data to a network database and subsequently delete the user data from the targeted device.

The reserve power routine 103 may be operable to maintaining a power reserve for the location, tracking and/or recovery process. For example, power may be reserved for determining location/GPS fixes, capturing image data and communicating with the remote communication device, such as a secondary wireless device, PC or network entity. The power reserve routine 103 may implement a timer to “awaken”/power-up the device at predetermined intervals for determining a location, capturing image data, setting off a sensory alarm and/or communicating with the remote communication device. In addition, the power reserve routine 103 may implement a timer to provide for the device to execute a sleep mode, standby mode or auto-shutoff after a predetermined time period. In alternate aspects, the reserve power routine 103 may implement and/or the targeted wireless device 14 may include a back-up power supply, such as a secondary battery or solar-cell that is implemented if the primary battery is removed or damaged, such as removal/damage by a thief, criminal or the like. In addition to primary power source failure or exhaustion, the reserve power routine 103 and/or back-up power supply may be executed or implemented in response to predetermined events, including but not limited to periodic time intervals, an SMS message, an emergency signal, a voice command, or the like.

Other locating-related routines 104 may include, but are not limited to, a routine for changing an operational mode, such as changing the targeted device from an “off” state to an “on” state or a limited “on” state”. Additionally, changing an operational mode may include changing from a “silent”, “vibrate” or “low-volume” ring state to an “audible” or “high volume” ring state to facilitate locating a misplaced, lost or stolen targeted device.

Additionally, locating-related routines 104 may include communication corruption routine operable for corrupting any and/or all communication transmitted from and received by the targeted wireless device 14. For example, a communication corruption routine may “jam” communications, such as voice, data and the like by introducing noise or otherwise scrambling any and/or all transmitted and received communication signals. In such aspects, the wireless device may include a scrambler 83 in the processing subsystems 74 that may be remotely accessed. The scrambler is operable to inject random noise into all communications, including voice, text, images and video data. The scrambler may also use a secondary radio transmitter, for example, to emit a jamming signal with additional white-Gaussian-noise.

As previously noted, the locating state 58 is associated with one or more locating routines 60 and, in some aspects, the locating state 58 is associated with a sequence of locating routines. For example, a stolen state may define a sequence of locating routines that initially perform location determination routine 94, audio capture routine 90, and/or image capture routine 92, followed by sensory alarm routine 96, user data lockdown/retrieval/deletion routine 102 and/or disablement routines 98 and/or 100. In another example, a misplaced state may define a sequence of sensory alarm routine 96 followed by lockdown/retrieval deletion routine 102 and/or disablement routines 98 and 100, if the device is not located within a prescribed time period.

Additionally, as previously noted, target wireless communication device 14 has input mechanism 108 for generating inputs into communication device, and output mechanism 110 for generating information for consumption by the user of the communication device. For example, input mechanism 108 may include a mechanism such as a key or keyboard, a mouse, a touch-screen display, a microphone, etc. In certain aspects, the input mechanisms 108 provide for user input to interface with an application, such as communication module 46 and/or location/recovery module 56. Further, for example, output mechanism 110 may include a display, an audio speaker, a haptic feedback mechanism, etc. In the illustrated aspects, the output mechanism 110 may include a display operable to display messages or visual alerts/alarms to the finder/thief of the target device 14.

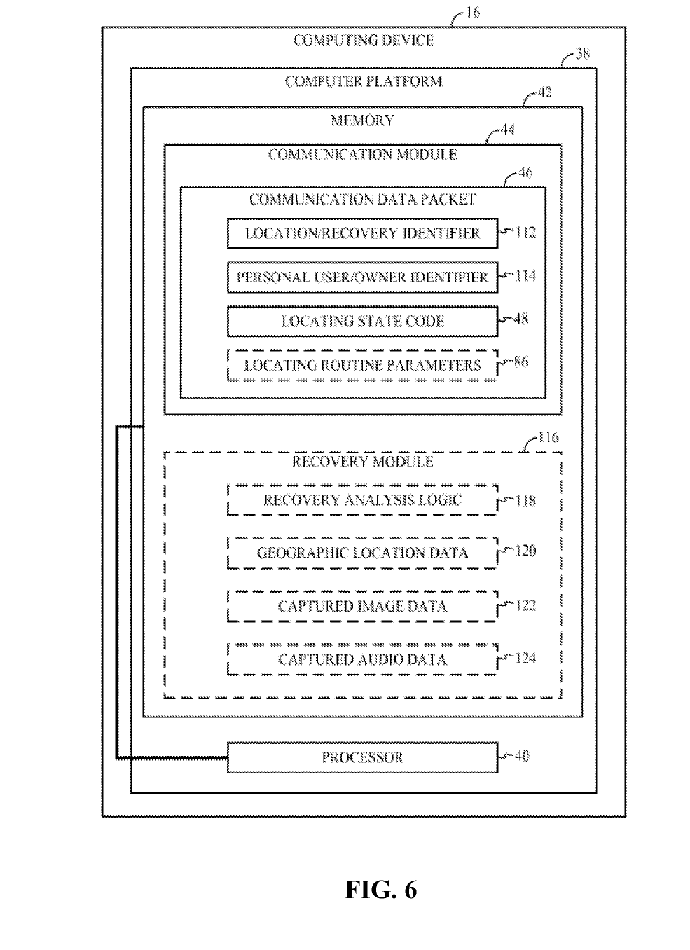

Referring to FIG. 6, according to another aspect, a detailed block diagram of a computing device 16, 18, 20 operable to generate and communicate a communication data packet that includes a location state code. The computing device 16, 18, 20 may include any type of computerized, communication device, such as personal computer (PC), cellular telephone, Personal Digital Assistant (PDA), two-way text pager, portable computer, and even a separate computer platform that has a wireless communications portal, and/or may have a wired connection to a network or the Internet. The wired or wireless computing device can be a remote-slave, or other device that does not have an end-user thereof but simply communicates data across a wired or wireless network, such as remote sensors, diagnostic tools, data relays, and the like. The present computing apparatus and associated methods can accordingly be performed on any form of wired or wireless computing device or wireless computer module, including a wireless communication portal, including without limitation, wireless modems, PCMCIA cards, access terminals, desktop computers or any combination or sub-combination thereof.

The computing device 16, 18, 20 includes computer platform 38 that can transmit data across a wireless and/or wired network, and that can receive and execute routines and applications. Computer platform 38 includes memory 42, which may comprise volatile and nonvolatile memory such as read-only and/or random-access memory (RAM and ROM), EPROM, EEPROM, flash cards, or any memory common to computer platforms. Further, memory 42 may include one or more flash memory cells, or may be any secondary or tertiary storage device, such as magnetic media, optical media, tape, or soft or hard disk. Further, computer platform 38 also includes processor 40, which may be an application-specific integrated circuit (“ASIC”), or other chipset, processor, logic circuit, or other data processing device.

Memory 42 of computer platform 38 additionally includes communications module 44 operable for generating and communicating communication data packet 46, which may correspond to a voice call packet or a data call packet. In one aspect, communication data packet 46 is defined as a Short Message Service (SMS) data packet. The communication data packet 46 may include a location/recovery identifier 112 operable for identifying the communication data packet as a location/recovery related communication data packet that provides for executing the related location/recovery module 56 upon receipt by the target device 14. The communication data packet 46 may additionally include a personal user/owner identifier 114 operable for authenticating the user/owner of the target device and/or the network service provider as an individual or entity authorized to perform location, tracking and/r recovery on the target device 14. Additionally, the communication data packet 46 includes a locating state code 48 that is associated with one of a plurality of locating states, which are operable on the target device 14. Each locating state being associated with one or more predetermined location routines that are executable on the target devices 14. The communication data packet 48 may additionally include locating routine parameters 86 defined in variable length field that allows for text inputs. By defining locating routine parameters in the communication data packet, the user/owner of the target device or the authorized sending entity is able to dynamically control the location, tracking and attempted recovery of the target device.

The memory 42 of computer platform 38 may include recovery module 116 that includes recovery analysis logic 118 operable for analyzing the data captured by the target device. The recovery analysis logic 118 may analyze captured and uploaded geographic location data 120, image data 122 and/or audio data 124 to determine the location of the target device 14 and/or the identity of the finder/thief. While the recovery module 116 is depicted as being embodied in the same device that generates and sends the communication data packet to the target device to initiate the location/recovery process, in many aspects, the recovery module 116 may be embodied in a separate network device, such as a service provider controlled network device, a tracking service controlled network device, a law enforcement controlled network device or the like.

In one aspect, a recovery module 116 may further include a target device messaging module. In one aspect, the target device messaging module may be operable to repeatedly and/or periodically transmit messages to the target device. For example, such messages may include SMS messages, emails, instant messages, data calls, IP calls, etc.

In one aspect, a recovery module 116 may further include a plotting module to allow plotting the location of one or more associated wireless devices through an associated map plotting program, etc.

In another aspect, a recovery module 116 may further include an authentication module to provide identifying information to associated wireless devices. Such information may allow additional access to the wireless device and/or may limit initial communications with the wireless device. Authenticated tracking may reduce any likelihood of intermediary intercepts, inclusion of unwanted messages, etc.

In one aspect, a recovery module 116 may further include a parental control module. In such an aspect, the parental control module may allow for disablement of the wireless device at specific locations (e.g. school, church, etc.). Further, the parental control module may provide for a web-based interface to control at least a portion of data/voice interactions with specific wireless devices. For example, specific web content may be restricted and/or specific numbers may be blocked. Still further, the parental control module may allow for detection of whether specific locations have been visited. For example, the module may determine if the device (and presumably the child) visited a library or a mall after school, or if the child left the service coverage area. In another aspect, the parental control module may be used to remotely disable at least a portion of the functionalities of an associated wireless device.

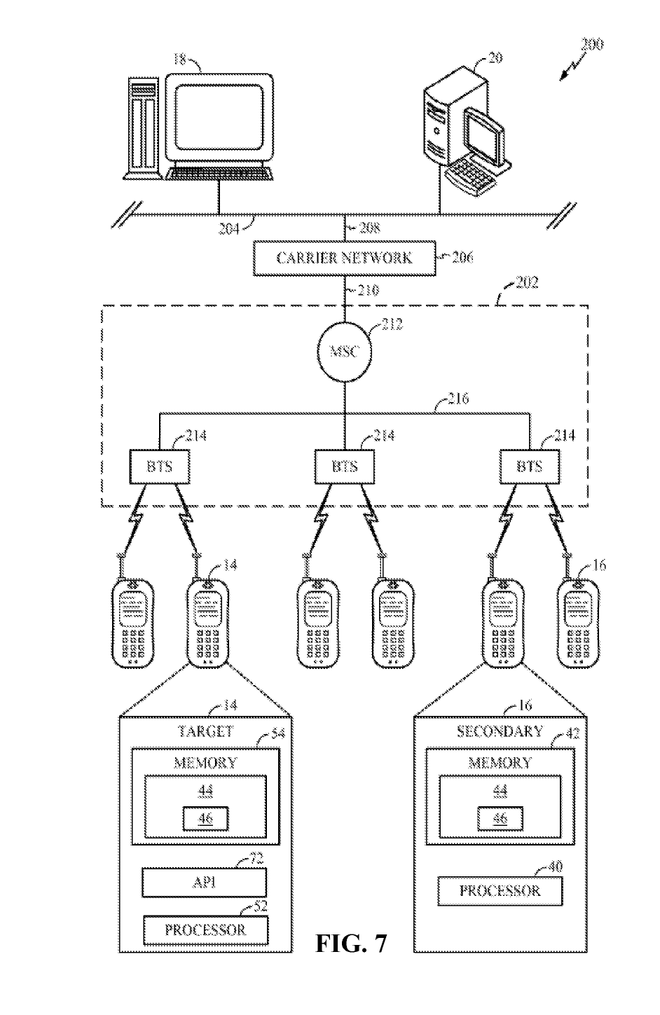

FIG. 7 represents a block diagram of a cellular network 200. A wireless network 202 may comprise a cellular network 200 and, as such may be implemented to communicate communication data packets 46 to the target wireless device 14, and upload captured data from target wireless device 14 to computer devices 16, 18 and/or 20. Referring to FIG. 7, in one aspect, target wireless device 14 and alternate/secondary wireless device 16 comprise a wireless communication device, such as a cellular telephone. In present aspects, wireless communication devices are configured to communicate via the cellular network 200. The cellular network 200 provides wireless communication devices 14 and 16 the capability to communicate communication data packets and upload captured data related to locating and recovering a target device. The cellular telephone network 200 may include wireless network 202 connected to a wired network 204 via a carrier network 206. FIG. 7 is a representative diagram that more fully illustrates the components of a wireless communication network and the interrelation of the elements of one aspect of the present system. Cellular telephone network 200 is merely exemplary and can include any system whereby remote modules, such as wireless communication devices 14 and 16 communicate over-the-air between and among each other and/or between and among components of a wireless network 202, including, without limitation, wireless network carriers and/or servers.

In network 200, personal computer 18, can be in communication over a wired network 204 (e.g. a local area network, LAN). Further, a network server 20, such as service provider server 20 may be in communication with network device 18 via the wired network 204. PC 18 and network device may generate and communicate communication data packets 46 and upload location related captured data from the target device 14. PC 18 and network server 20 may be present on the cellular telephone network 200 with any other network components that are needed to provide cellular telecommunication services. PC 18, and/or network server 20 communicate with carrier network 206 through a data links 208 and 210, which may be data links such as the Internet, a secure LAN, WAN, or other network. Carrier network 206 controls messages (generally being data packets) sent to a mobile switching center (“MSC”) 212. Further, carrier network 206 communicates with MSC 212 by a network 210, such as the Internet, and/or POTS (“plain old telephone service”). Typically, in network 210, a network or Internet portion transfers data, and the POTS portion transfers voice information. MSC 212 may be connected to multiple base stations (“BTS”) 214 by another network 216, such as a data network and/or Internet portion for data transfer and a POTS portion for voice information. BTS 214 ultimately broadcasts messages wirelessly to the wireless communication devices 14 and 16, by short messaging service (“SMS”), or other over-the-air methods.

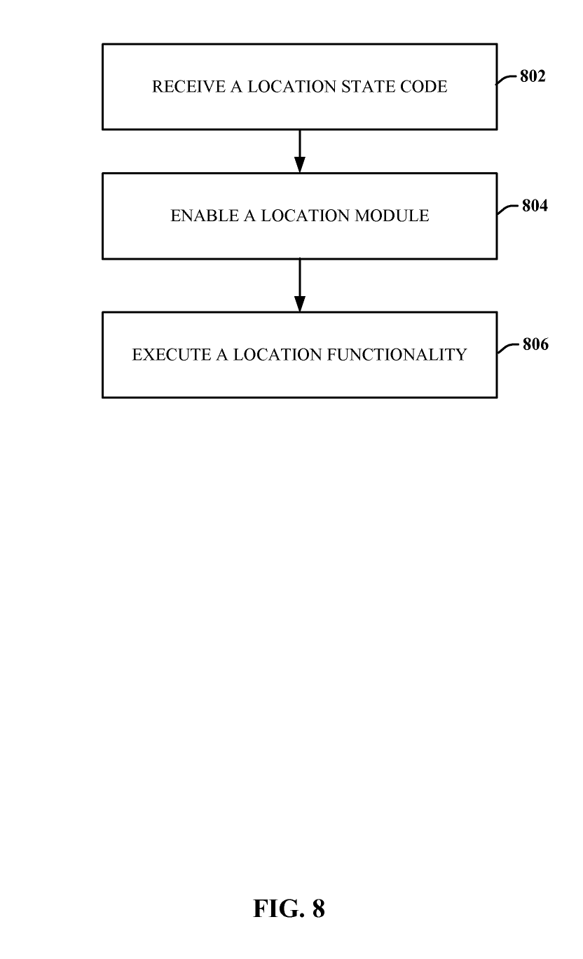

FIG. 8 illustrates various methodologies in accordance with various aspects of the presented subject matter. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Turning now to FIG. 8, exemplary method 800 for facilitating location of a targeted wireless communication device is illustrated. Generally, at reference numeral 802 a location state code may be received. In one aspect, the location state code may be received from a search entity, a searching device, etc. At reference numeral 804, the received location state code may be processed to enable at least one location module to be enabled. In one aspect, the enabled location module may further enable one or more device functionalities through various other modules, such as but not limited to: through an announcement module, an auto-dialing module, a display modification module, an operation modification module, a position modification module, a content modification module, a uncertainty zone module, an object recognition module, a persistence module a device identification module, an electronic leash module, a secondary user module, etc. At reference numeral 806 at least one module enabling the location functionalities is executed.

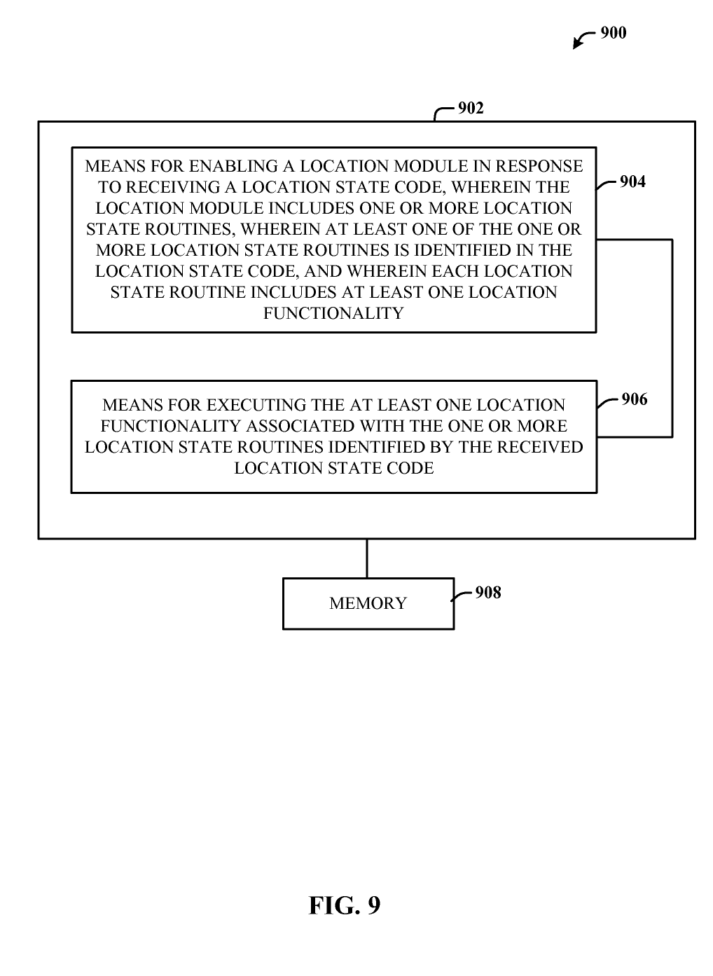

With reference to FIG. 9 a block diagram of an exemplary system 900 that can facilitate efficient handover is illustrated. For example, system 900 can reside at least partially within a wireless device. According to another example aspect, system 900 can reside at least partially within an access terminal. It is to be appreciated that system 900 is represented as including functional blocks, which can be functional blocks that represent functions implemented by a processor, software, or combination thereof (e.g., firmware). System 900 includes a logical grouping 902 of means that can act in conjunction. For instance, logical grouping 902 can include means for enabling a location module in response to receiving a location state code, wherein the location module includes one or more location state routines, wherein at least one of the one or more location state routines is identified in the location state code, and wherein each location state routine includes at least one location functionality 904. Further, logical grouping 902 can comprise means for executing the at least one location functionality associated with the one or more location state routines identified by the received location state code 906. In one aspect, the at least one functionality may include functionalities executed through an announcement module, an auto-dialing module, a display modification module, an operation modification module, a position modification module, a content modification module, a uncertainty zone module, an object recognition module, a persistence module a device identification module, an electronic leash module, a secondary user module, etc.

Additionally, system 900 can include a memory 908 that retains instructions for executing functions associated with the means 904 and 906. While shown as being external to memory 908, it is to be understood that one or more of the means 904 and 906 can exist within memory 908.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method for facilitating location of a targeted wireless communications device (WCD), comprising:
enabling a location module in response to receiving a location state code, wherein the location module includes one or more location state routines, wherein at least one of the one or more location state routines is identified in the location state code, and wherein each location state routine includes at least one location functionality; and
executing the at least one location functionality associated with the one or more location state routines identified by the received location state code.

2. The method of claim 1, wherein the at least one location functionality includes an audio announcement functionality, and wherein the audio announcement functionality is operable for:
determining that the targeted WCD is operating in a vibration or silent mode;
modifying the operation mode of the targeted WCD to enable at least one of an audio component and a display component of the targeted WCD; and
presenting a location message using at least one of the audio component or display component.

3. The method of claim 1, wherein the at least one location functionality includes an auto-dialing functionality, and wherein the auto-dialing functionality is operable for enabling a preset contact to be at least displayed or contacted, wherein the preset contact is at least one of: a user defined home number, or a call center number.

4. The method of claim 1, wherein the at least one location functionality includes a display modification functionality, and wherein the display modification functionality is operable for modifying at least a portion of the operations of a display on the target WCD by performing at least one of: displaying a blank screen, displaying a radio frequency (RF) signal strength indicator to falsely display a reduced value, displaying a battery indictor to falsely display a reduced value, displaying a predetermined color or combination of colors, changing an intensive value for the display, changing a refresh rate for the display.

5. The method of claim 1, wherein the at least one location functionality includes an operation modification functionality, and wherein the operation modification functionality is operable for modifying at least one of the targeted WCD power status or RF transceiver status.

6. The method of claim 1, wherein the at least one location functionality includes an operation modification functionality, and wherein the operation modification functionality is operable for locking the targeted WCD in response to a received message from a recovery service, wherein the recovery service performed an authentication process before generating the message.

7. The method of claim 6, wherein the authentication process includes receiving a user identification which is associated with the targeted WCD.

8. The method of claim 7, wherein the user identification includes a payment instruction.

9. The method of claim 6, further comprising:
receiving an unlock message, wherein the unlock message is transmitted by the recovery service upon a determination that a user has provided a payment to the recovery service.

10. The method of claim 9, wherein the unlock message is received from at least one of: a user input on the target WCD, or from the recovery service.

11. The method of claim 6, further comprising:
unlocking the targeted WCD after receiving an input on a user interface of the target WCD, wherein the received input indicates completion of the authentication process.

12. The method of claim 1, wherein the at least one location functionality includes a content modification functionality, and wherein the content modification functionality is operable for modifying content stored on the targeted WCD, wherein such content modification includes at least one of: encrypting at least a portion of the stored content, shielding at least a portion of the stored content, deleting at least a portion of the stored content, or transmitting at least a portion of the stored content to another entity.

13. The method of claim 1, wherein the at least one location functionality includes a physical position modification functionality, and wherein the physical position modification functionality is operable for modifying the physical positioning of at least a portion of the targeted WCD.

14. The method of claim 13, wherein the modifying the physical positioning of at least a portion of the targeted WCD comprises at least one of moving, rotating, or manipulating a camera associated with the targeted WCD to provide an image of the surroundings in which the targeted WCD is located, wherein the provided image is either a still or moving image.

15. The method of claim 14, further comprising:
determining that the provided image is indicates the targeted WCD camera view is blocked, and
wherein the modifying the physical positioning of at least a portion of the targeted WCD comprises initiating a sequence of vibrations to rotate or flip the targeted WCD.

16. The method of claim 13, wherein the modifying the physical positioning of at least a portion of the targeted WCD comprises initiating a sequence of vibrations to rotate or flip the targeted WCD.

17. The method of claim 1, wherein the at least one location functionality includes an uncertainty zone functionality, and wherein the uncertainty zone functionality is operable for defining a geographic boundary around the targeted WCD within which a first communication protocol used for locating the targeted WCD lacks location clarity above a defined threshold.

18. The method of claim 17, further comprising:
transmitting the defined geographic boundary to a searching device.

19. The method of claim 17, further comprising:
detecting a searching device is within the defined geographic boundary; and
activating at least one of: an audio announcement, a visual display, or a communication link with the searching device.

20. The method of claim 1, further comprising:
determining the location state code is received from an unauthorized searching device; and
transmitting location information which is either scrambled or incorrect to the unauthorized searching device.

21. The method of claim 1, wherein the at least one location functionality includes an object recognition functionality, and wherein the object recognition functionality is operable for:
obtaining an image or video by the targeted WCD;
analyzing the obtained image to determine a recognized object is present; and
activating at least one of an audio announcement or a visual display is response to determined recognized object.

22. The method of claim 1, wherein the at least one location functionality includes an environmental detection functionality, and wherein the environmental detection functionality is operable for detecting at least one of light, temperature, smell, vibration, noise, or pressure, or a change in detecting at least one of light, temperature, smell, vibration, noise, or pressure.

23. The method of claim 22, wherein the environmental detection functionality is further operable for:
detecting the targeted WCD is within a geographic area of interest; and
displaying a message identifying the geographic area of interest.

24. The method of claim 1, wherein the at least one location functionality includes a persistence functionality, and wherein the persistence functionality is operable for enabling the targeted WCD to store at least the location state code in a persistent memory, wherein the persistent memory is operable to retain the stored location state code through a change to at least one of the targeted WCD battery, hardware, firmware, or software.

25. The method of claim 1, wherein the at least one location functionality includes a device specific identification functionality, and wherein the device specific identification functionality is operable for enabling the targeted WCD to store at least a portion of uniquely identifying information the targeted WCD.

26. The method of claim 25, wherein the uniquely identifying information for the targeted WCD is obtained from at least one of: an R-UIM card, a SIM card, a virtual SIM card, or any combination thereof.

27. The method of claim 25, further comprising:
determining a new uniquely identifying information item is coupled to the targeted WCD;
determining the new uniquely identifying information item is different than the stored uniquely identifying information for the targeted WCD; and
disabling at least one functionality associated with the targeted WCD.

28. The method of claim 1, wherein the at least one location functionality includes an electronic leash functionality, and wherein the electronic leash functionality is operable for:
determining that the targeted WCD is no longer within a defined proximity of at least one second device; and
disabling at least one functionality associated with the targeted WCD in response to the determination.

29. The method of claim 1, wherein the at least one location functionality includes an electronic leash functionality, and wherein the electronic leash functionality is operable for:
determining that the targeted WCD is no longer within a defined proximity of at least one second device; and
alerting the targeted WCD that the determined second device is no longer within the defined proximity.

30. The method of claim 1, wherein the at least one location functionality includes a secondary user control functionality, and wherein the secondary user control functionality is operable for enabling a secondary user to select at least one location in which at least one functionality associated with the targeted WCD is disabled.

31. The method of claim 1, further comprising:
transmitting location data to a search entity to enable to the search entity to plot the location of the targeted WCD on a map.

32. At least one processor configured to facilitate location of a targeted WCD, comprising:
a first module for enabling a location module in response to receiving a location state code, wherein the location module includes one or more location state routines, wherein at least one of the one or more location state routines is identified in the location state code, and wherein each location state routine includes at least one location functionality; and
a second module for executing the at least one location functionality associated with the one or more location state routines identified by the received location state code.

33. An apparatus, comprising:
means for enabling a location module in response to receiving a location state code, wherein the location module includes one or more location state routines, wherein at least one of the one or more location state routines is identified in the location state code, and wherein each location state routine includes at least one location functionality; and
means for executing the at least one location functionality associated with the one or more location state routines identified by the received location state code.

34. A computer program product, comprising:
a computer-readable medium comprising:
a first set of codes for causing a computer to enable a location module in response to receiving a location state code, wherein the location module includes one or more location state routines, wherein at least one of the one or more location state routines is identified in the location state code, and wherein each location state routine includes at least one location functionality; and
a second set of codes for causing the computer to execute the at least one location functionality associated with the one or more location state routines identified by the received location state code.

35. A targeted wireless communications device (WCD), comprising:
a location recovery module operable to:
enable the location recovery module in response to receiving a location state code, wherein the location module includes one or more location state routines, wherein at least one of the one or more location state routines is identified in the location state code, and wherein each location state routine includes at least one location functionality; and
execute the at least one location functionality associated with the one or more location state routines identified by the received location state code.

36. The targeted WCD of claim 35, wherein the at least one location functionality includes an audio announcement functionality, and wherein the audio announcement functionality is operable to:
determine that the targeted WCD is operating in a vibration or silent mode;
modify the operation mode of the targeted WCD to enable at least one of an audio component and a display component of the targeted WCD; and
present a location message using at least one of the audio component or display component.

37. The targeted WCD of claim 35, wherein the at least one location functionality includes an auto-dialing functionality, and wherein the auto-dialing functionality is operable to enable a preset contact to be at least displayed or contacted, wherein the preset contact is at least one of: a user defined home number, or a call center number.

38. The targeted WCD of claim 35, wherein the at least one location functionality includes a display modification functionality, and wherein the display modification functionality is operable to modify at least a portion of the operations of a display on the target WCD by performing at least one of: displaying a blank screen, displaying a radio frequency (RF) signal strength indicator to falsely display a reduced value, displaying a battery indictor to falsely display a reduced value, displaying a predetermined color or combination of colors, changing an intensive value for the display, or changing a refresh rate for the display.

39. The targeted WCD of claim 35, wherein the at least one location functionality includes an operation modification functionality, and wherein the operation modification functionality is operable to modify at least one of the targeted WCD power status or RF transceiver status.

40. The targeted WCD of claim 35, wherein the at least one location functionality includes an operation modification functionality, and wherein the operation modification functionality is operable to lock the targeted WCD in response to a received message from a recovery service, wherein the recovery service performed an authentication process before generating the message.

41. The targeted WCD of claim 40, wherein the authentication process includes receiving a user identification which is associated with the targeted WCD.

42. The targeted WCD of claim 41, wherein the user identification includes a payment instruction.

43. The targeted WCD of claim 40, further comprising:
receiving an unlock message, wherein the unlock message is transmitted by the recovery service upon a determination that a user has provided a payment to the recovery service.

44. The targeted WCD of claim 43, wherein the unlock message is received from at least one of: a user input on the target WCD, or from the recovery service.

45. The target WCD of claim 6, wherein the operation modification functionality is further operable to:
unlock the targeted WCD after receiving an input on a user interface of the target WCD, wherein the received input indicates completion of the authentication process.

46. The targeted WCD of claim 35, wherein the at least one location functionality includes a content modification functionality, and wherein the content modification functionality is operable to modify content stored on the targeted WCD, wherein such content modification includes at least one of: encrypting at least a portion of the stored content, shielding at least a portion of the stored content, deleting at least a portion of the stored content, or transmitting at least a portion of the stored content to another entity.

47. The targeted WCD of claim 35, wherein the at least one location functionality includes a physical position modification functionality, and wherein the physical position modification functionality is operable to modify the physical positioning of at least a portion of the targeted WCD.

48. The targeted WCD of claim 47, wherein the modifying the physical positioning of at least a portion of the targeted WCD comprises at least one of moving, rotating, or manipulating a camera associated with the targeted WCD to provide an image of the surroundings in which the targeted WCD is located, wherein the provided image is either a still or moving image.

49. The target WCD of claim 48, wherein the physical position modification functionality is operable to determine that the provided image is indicates the targeted WCD camera view is blocked wherein the modifying the physical positioning of at least a portion of the targeted WCD comprises initiating a sequence of vibrations to rotate or flip the targeted WCD.

50. The targeted WCD of claim 47, wherein the modifying the physical positioning of at least a portion of the targeted WCD comprises initiate a sequence of vibrations to rotate or flip the targeted WCD.

51. The targeted WCD of claim 35, wherein the at least one location functionality includes an uncertainty zone functionality, and wherein the uncertainty zone functionality is operable to define a geographic boundary around the targeted WCD within which a first communication protocol used for locating the targeted WCD lacks location clarity above a defined threshold.

52. The targeted WCD of claim 51, further comprising a transmitter operable to transmit the defined geographic boundary to a searching device.

53. The targeted WCD of claims 51, wherein the location recovery module is further operable to:
detect a searching device is within the defined geographic boundary; and
activate at least one of: an audio announcement, a visual display, or a communication link with the searching device.

54. The targeted WCD of claim 35, wherein the location recovery module is further operable to determine the location state code is received from an unauthorized searching device; and
further comprising a transmitter operable to transmit location information which is either scrambled or incorrect to the unauthorized searching device.

55. The target WCD of claim 35, wherein the at least one location functionality includes an object recognition functionality, and wherein the object recognition functionality is operable to:
obtain an image or video by the targeted WCD;
analyze the obtained image to determine a recognized object is present; and
activate at least one of an audio announcement or a visual display is response to determined recognized object.

56. The target WCD of claim 35, wherein the at least one location functionality includes an environmental detection functionality, and wherein the environmental detection functionality is operable to detect at least one of light, temperature, smell, vibration, noise, or pressure, or a change in detecting at least one of light, temperature, smell, vibration, noise, or pressure.

57. The target WCD of claim 56, wherein the environmental detection functionality is further operable to:
detect the targeted WCD is within a geographic area of interest; and
display a message identifying the geographic area of interest.

58. The target WCD of claim 35, wherein the at least one location functionality includes a persistence functionality, and wherein the persistence functionality is operable to enable the targeted WCD to store at least the location state code in a persistent memory, wherein the persistent memory is operable to retain the stored location state code through a change to at least one of the targeted WCD battery, hardware, firmware, or software.

59. The target WCD of claim 35, wherein the at least one location functionality includes a device specific identification functionality, and wherein the device specific identification functionality is operable to enable the targeted WCD to store at least a portion of uniquely identifying information the targeted WCD.

60. The target WCD of claim 59, wherein the uniquely identifying information for the targeted WCD is obtained from at least one of: an R-UIM card, a SIM card, a virtual SIM card, or any combination thereof.

61. The target WCD of claim 59, wherein the location recovery module is further operable to:
determine a new uniquely identifying information item is coupled to the targeted WCD;
determine the new uniquely identifying information item is different than the stored uniquely identifying information for the targeted WCD; and
disable at least one functionality associated with the targeted WCD.

62. The target WCD of claim 35, wherein the at least one location functionality includes an electronic leash functionality, and wherein the electronic leash functionality is operable to:
determine that the targeted WCD is no longer within a defined proximity of at least one second device; and
disable at least one functionality associated with the targeted WCD in response to the determination.

63. The target WCD of claim 35, wherein the at least one location functionality includes a secondary user control functionality, and wherein the secondary user control functionality is operable to enable a secondary user to select at least one location in which at least one functionality associated with the targeted WCD is disabled.

64. The target WCD of claim 35, further comprising a transmitter operable to transmit location data to a search entity to enable to the search entity to plot the location of the targeted WCD on a map.
